(19) United States
(12) Patent Application Publication
(10) Pub. No.: US 2026/0289541 A1
(43) Pub. Date: Sep. 24, 2026

(54) SYSTEM FOR IMPLEMENTING FLEXIBLE CREDENTIALS

(71) Applicant: Wells Fargo Bank, N.A., San Francisco, CA (US)

(72) Inventors: Angela M. Sicord, San Francisco, CA (US); Lucy Xi Zhang, Walnut Creek, CA (US)

(21) Appl. No.: 19/086,740

(22) Filed: Mar. 21, 2025

(51) Int. Cl. G06Q 20/22; G06Q 20/40

(52) U.S. Cl. CPC G06Q 20/227; G06Q 20/29; G06Q 20/405

(57) ABSTRACT

A system for processing a transaction for a flexible credential may be configured to receive, from a payment network, an indication of a payment transaction involving an accountholder of a group payment account, the payment transaction including a payment amount, the flexible credential linked to the group payment account, and the group payment account including a plurality of members; evaluate rules established by the accountholder to determine: a) a set of funding sources to use in the payment transaction, each of the set of funding sources held by a different member of the plurality of members, and b) a respective portion of the payment amount to be allocated to each of the set of funding sources; and complete the payment transaction by initiating separate payment transactions with each of the set of funding sources for the respective portion of the payment amount.

### BACKGROUND

A payment credential is a secure piece of information that authorizes a financial transaction and verifies the identity or access rights of the payer. It typically includes details linked to a payment method, such as a credit or debit card number, online payment account, or digital wallet token. These credentials are essential for enabling transactions across various platforms, including online, in-store, and mobile payment systems.

To ensure security, payment credentials are often encrypted or tokenized, replacing sensitive data with unique identifiers that reduce the risk of fraud. They may also incorporate additional authentication mechanisms like personal identification numbers (PINs), biometric data (e.g., fingerprints or facial recognition), or one-time passwords (OTPs). By securely linking payment methods to users, payment credentials facilitate seamless and trusted transactions in the digital economy.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a diagram illustrating an operating environment, according to an embodiment;

FIG. 2 is a flow diagram illustrating a process for evaluating rules, according to an embodiment;

FIG. 3 is a diagram illustrating an arrangement of group members in a group payment account, according to an embodiment;

FIG. 4 is a flowchart illustrating a method for forming a group payment account, according to an embodiment;

FIG. 5 is an example user interface of an application used to configure rules, according to an embodiment;

FIG. 6 is a flowchart illustrating a method for processing a transaction for a flexible credential, according to an embodiment; and

FIG. 7 is a block diagram illustrating an example machine upon which any one or more of the techniques (e.g., methodologies) discussed herein may perform, according to an example embodiment.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

Systems and methods described herein provide mechanisms for implementing flexible credentials. In the financial services industry, a credential refers to a piece of information, data, or authentication method used to verify the identity of a user, institution, or device and authorize access to financial accounts, systems, or services. One type of flexible credential is a physical payment card (also referred to as a payment credential, or credential) that is able to access (or be funded by) several different financial accounts. This type of flexible, configurable credential reduces the number of physical credentials a person has to carry while maintaining backwards compatibility with an infrastructure built around card readers and other devices that read a payment credential at point the sale (POS). Credentials are essential for ensuring the security and integrity of financial transactions, as they help prevent unauthorized access and fraud. A payment credential is used as a substitute for cash currency and provides a secured mechanism to pass account information during a commercial transaction.

A flexible credential is an adaptable authentication method designed to work across various platforms, services, or contexts while maintaining robust security. In the financial services industry, these credentials provide both convenience and protection by accommodating different authentication needs without being restricted to a single use case or technology. They are built to adapt to diverse scenarios, such as accessing banking apps, authorizing payments, or using digital wallets, making them highly versatile.

A “flexible credential” allows a cardholder to use a single card to access multiple funding sources like a checking account, one or more credit lines, or rewards points. This flexible credential in combination with a smartphone app or other controlling application lets the card holder choose which account to use for each transaction based on their preferences, all through one payment card. This provides a card holder a mechanism to pay with a single card and access different funding sources depending on the situation.

A flexible credential may be configured using an application (e.g., an app on a mobile device) to draw from one or more accounts. These accounts may be a credit line, a savings account, a brokerage account, a loyalty points account, a designated prepaid fund, or the like. The financial accounts may all be under one financial institution or may span several institutions. Additionally, and optionally, a flexible credential may be siloed in a single payment network or may be payment network agnostic, able to be used across multiple payment networks. Using an application, the user/consumer may configure the flexible credential to draw from a desired account based on various rules. A default funding source may be used when rules are not established or when no rules apply to a given situation.

There are several challenges when using payment credentials amongst a group of people. For instance, when a group of people are sharing a meal, travel, or other types of expenses, there comes a time when the total due for the expense has to be separated among the responsible parties. Having one party pay for the entire expense and then collect reimbursement from other parties is one method of addressing this situation. However, it becomes overly complicated when there are several transactions to reconcile, which may have occurred over an extended period. For instance, when multiple families are travelling through Europe together, it is difficult to track shared expenses back to the responsible family. Further, having to collect the reimbursement from the responsible party is undue burden on the party that initially covered the expense.

What is needed is a more adaptive mechanism for using flexible credentials in a group situation that provides transactional transparency, auditing, and ease of use. The systems and methods described herein provide a group credential platform where multiple people may register or enroll to use a group credential. The group credential may be linked to each person's own flexible credential, such that when the group credential platform processes payments charged to a group payment credential for a specific event, using metadata, the payment requests are forwarded to the underlying issuing authorities for each of the people using the group credential. The group credential platform also provides an audit trail for all parties that use the group credential.

A group credential is a payment credential that is accessible to a group of people. For instance, each person in a group may have their own flexible credential (e.g., digital wallet, physical credit card, credit card app, etc.), that is able to access the same group payment credential. The group payment credential is used by the merchant to process the transaction. The group credential platform then uses independent payment credentials to separately process parts of the transaction for each member of the group.

Group payment credentials may be defined dynamically to be used for a certain event, during a certain period, or for other use cases where expenses are shared among several people. Group payment credentials may combine multiple security layers, such as biometrics, device-based tokens, or PINs, which can be tailored to the sensitivity of the transaction. They are also interoperable, ensuring compatibility with a wide range of systems and devices. Examples include tokenized payment methods that replace sensitive account information, biometric authentication used for banking apps and ATMs, or single sign-on (SSO) solutions that grant access to multiple services. By balancing security and usability, group credentials enhance user experience and adaptability in the increasingly interconnected financial ecosystem. These functions and others are described in more detail below.

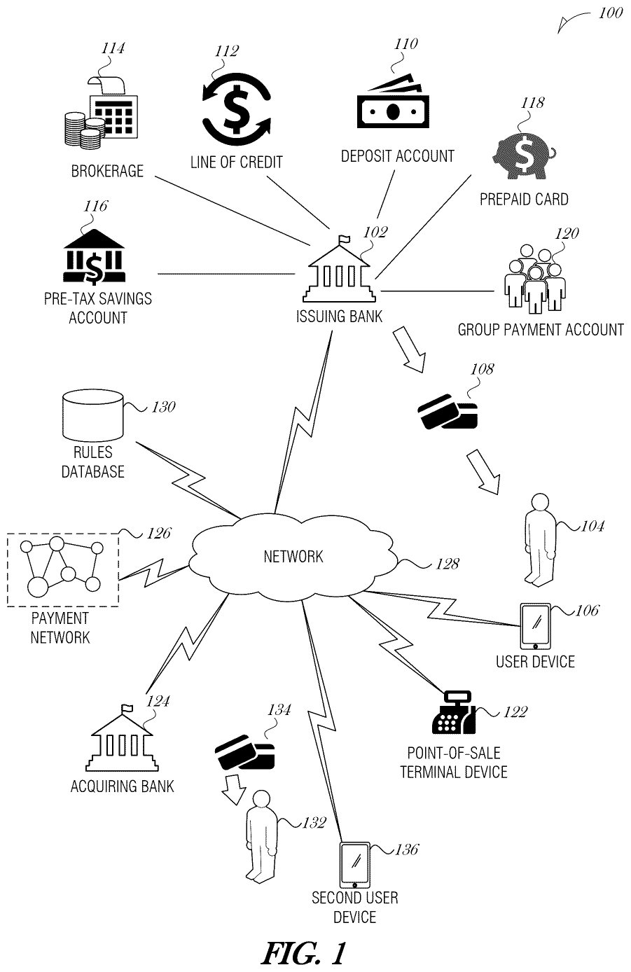

FIG. 1 is a diagram illustrating an operating environment 100, according to an embodiment. Payment credentials are managed using three primary entities: a credential issuer, a credential holder, and a credential verifier. In the case of a payment credential, the credential issuer is typically a financial institution (e.g., a bank, credit union, credit card company, etc.), the credential holder is the person authorized to use the payment credential, and the verifier may be a business, service, or other person or entity that wants to validate the user's payment credential at a point-of-sale (POS). The POS may be an online store, a restaurant, a grocery checkout lane, a dentist office, or the like.

The credential holder typically provides permission to use a POS terminal device to read some or all of the data contained in the payment credential, which may include the person's name, account number, personal identification number, digital signature, card verification value (CVV) or card verification code (CVC), and the like.

For example, during a transaction where the card is physically presented (i.e., a card-present transaction), where customers physically swipe, insert, or tap a card at a point-of-sale (POS) terminal, the POS terminal may read data from the credential and transmit it to an acquiring bank associated with the merchant to settle the transaction. In an online or phone-based transaction (i.e., card-not-present transaction), the information may be provided electronically or verbally by the customer, and then later electronically transmitted to the acquiring bank. For instance, the customer may fill out a billing details form in a webpage to provide the card holder name, card number, CVV/CVC, billing address, and the like. This information may be sent via an application programming interface (API) to the acquiring bank. As another example, the customer may provide this information to an operator during a phone call. Other types of card-not-present transactions may be implemented through other communication channels (e.g., mail, text, written and sent through post mail, etc.).

During a card-present transaction, the POS terminal uses a POS provider system (e.g., Square, Toast, etc.) to connect to a payment network (e.g., Visa, Mastercard, Amex, Discover, Zelle, etc.), which communicates with the purchaser's bank (referred to as the issuer bank) to move money to the merchant's bank (referred to as the acquiring bank). In a card-not-present transaction, a backend system or a person enters the information via an application programming interface (API) or by other mechanisms to get the information into an electronic payment network.

In the environment illustrated in FIG. 1, an issuing bank 102 issues a flexible payment credential 108 to a user 104. The flexible payment credential 108 may be disposed in a standardized credit card form and include information printed or stamped on the substrate. The information may include the card holder's name, a credit card number, an expiration date, an indication of the issuing bank, an indication of the compatible payment network (e.g., Visa, Mastercard, Discover, Amex, etc.), and the like. The flexible payment credential 108 may include a magnetic stripe (magstripe) encoded with some or all of the information that is available on the substrate. Additionally, the flexible payment credential 108 may include an EMV (which stands for Europay, Mastercard, and Visa) chip, used to provide more secure payments. EMV chips create a one-of-a-kind code for each credit transaction to provide additional security. Additionally, the flexible payment credential 108 may optionally include a radio frequency identification (RFID) chip, used in contactless payments.

In addition to the physical flexible payment credential 108, the user 104 is able to download or otherwise obtain an application provided by the issuing bank 102. The application may be installed on a user device 106. The user device 106 may be of any type of mobile device including, but not limited to a smartphone, a laptop computer, a tablet device, a personal digital assistant, a wearable device (e.g., a smartwatch), or the like. The user 104 may use the application to configure the use of the flexible payment credential 108.

One way that the user 104 can configure the flexible payment credential 108 is to use a specific funding source for a payment based on one or more rules. The rules may be defined using the issuing bank's application on the user device 106 and stored in a rules database 130. The rules may be used to define that some transactions are processed to draw from a checking account and other transactions are processed to draw from a credit line. The rules may be based on the amount of the transaction, the type of merchant (e.g., the merchant category code (MCC) established by the International Organization for Standardization (ISO)), the day or time of the transaction, or other factors.

Returning to FIG. 1, the issuing bank 102 may provide multiple funding sources to the user 104 to settle the transaction. The sources include, but are not limited to a deposit account 110, line of credit 112, brokerage account 114, pre-tax savings account 116, prepaid card 118, a group payment account 120, or the like. The deposit account 110 may be a checking, savings, money market, or other account that the user 104 holds at the issuing bank 102 where the user 104 is able to deposit and withdraw money. The line of credit 112 may be a credit card, home equity line of credit (HELOC), personal loan, or other type of credit provided to the user 104 by the issuing bank 102. The brokerage account 114 may be a holding account for uninvested funds. The pre-tax savings account 116 may include health savings accounts (HSA), flexible spending accounts (FSA), heath reimbursement arrangement accounts (HRA), or the like.

A prepaid card 118 is also referred to as a reloadable debit card. A user 104 may use a prepaid card 118 in much the same was as a standard credit card or debit card. The key difference is that the prepaid card 118 is not linked to a line of credit 112. Instead, a prepaid card 118 is loaded (e.g., funded) with some amount of money. The prepaid card 118 may have a maximum value (e.g., a maximum amount that can be loaded on the prepaid card 118). As the user 104 purchases things or services and uses the prepaid card 118, the balance is reduced to reflect these purchases. The user 104 may reload the prepaid card 118 by funding it, for example, from a deposit account 110.

When the user 104 transacts in a purchase, the user 104 presents the flexible payment credential 108 to a POS terminal device 122 (in a card-present transaction) or provides information about the flexible payment credential 108 to have it entered (in a card-not-present transaction). The POS terminal device 122 transmits information to the acquiring bank 124 (the merchant's bank). Then a payment network 126 (e.g., Visa) acts as an intermediary, routing the transaction information to the issuing bank 102 for approval or denial, and then handling the transfer of funds from the issuing bank 102 to the acquiring bank 124.

When the issuing bank 102 receives a request to approve the transaction, the issuing bank 102 may determine that a flexible payment credential 108 was used and then determine which account to debit the funds from, based on the rules established in a rules database 130. The rules database 130 may be a part of a larger system that is hosted, managed, owned, operated, or otherwise provided by the issuing bank 102. The larger system may include an online banking system with mobile applications, web-based applications, or other electronic access to accounts at the issuing bank 102. The user 104 may establish user rules for how certain purchases should be processed. Additionally, the issuing bank 102 may establish bank rules for how various accounts may be used when purchasing goods or services. Also, default rules may be established by the issuing bank 102 or the user 104, where default rules are used when no other rule applies.

Based on the rules, the issuing bank 102 may approve or deny a transaction. If the issuing bank 102 approves the transaction, then the payment network 126 operates to move the money and notify the POS terminal device 122 that the transaction was a success. Alternatively, when the issuing bank 102 denies the transaction, then the payment network 126 operates to cancel the transaction and notify the POS terminal device 122 that the transaction failed.

The issuing bank 102, user device 106, POS terminal device 122, acquiring bank 102, and payment network 126 may be connected via a communication network 128. The communication network 128 may include one or more of local-area networks (LAN), wide-area networks (WAN), wireless networks (e.g., 802.11 or cellular network), the Public Switched Telephone Network (PSTN) network, ad hoc networks, cellular, personal area or peer-to-peer networks (e.g., Bluetooth®, Wi-Fi Direct), or other combinations or permutations of network protocols and network types. The communication network 128 may include a single local area network (LAN) or wide-area network (WAN), or combinations of LANs or WANs, such as the Internet.

Because the flexible payment credential 108 may be used to pay for purchases using various accounts including a prepaid card 118 and a deposit account 110, the user 104 effectively has a debit card to access a deposit account and a prepaid card to access the prepaid card 118. The flexible payment credential 108 may be extended to act as a credit card to access the line of credit 112 or as a debit/cash card to access the brokerage 114 or the pre-tax savings account 116. It is understood that multiple accounts of each type may be used in various embodiments. For example, the flexible payment credential 108 may be linked to both a consumer credit line and a business credit line, and the user 104 may access either credit line using the same flexible payment credential 108.

As shown in FIG. 1, one or more group payment accounts 120 may be issued by the issuing bank 102. A group payment account 120 is account that is formed and accessible by a group of people. The group of people may be related to the user 104 by various relationships including but not limited to friends, family, business associates, employees, or the like. Groups may be defined by the user 104, by one or more of the members of a group, by an employer of group members, by the issuing bank 102, or others.

Using a flexible credential, a second user 132 who is issued a second flexible payment credential 134, may select one or more group payment accounts 120 as a funding source for the second flexible payment credential 134. The second user 132 may share a group payment account 120 with the user 104, such that charges to the flexible payment credential 108 or the second flexible payment credential 134 are processed using the group payment account 120.

£ Not being a deposit account, line of credit, or other actual funding source, the group payment account 120 instead acts as a bridge account that links users to underlying payment accounts. For instance, user 104 may configure the flexible payment credential 108 to use the group payment account 120 in conjunction with a line of credit 112. The second user 132 may instead configure their second flexible payment credential 134 to use the group payment account 120 in conjunction with their checking account (not shown), effectively using their second flexible payment credential 134 as a debit card. By using the intermediary bridge group payment account 120, both the user 104 and the second user 132 are able to pay for shared expenses and then have the expenses allocated as per the rules that are applied to the group payment account 120, so that the expenses are charged to the underlying account that each user (104 and 132) configured for their respective flexible credential (108 and 134). The second user 132 may use a second user device 136 to configure the second flexible payment credential 134 with their respective issuing bank, which may not be the same issuing bank as the user 104 uses (issuing bank 102).

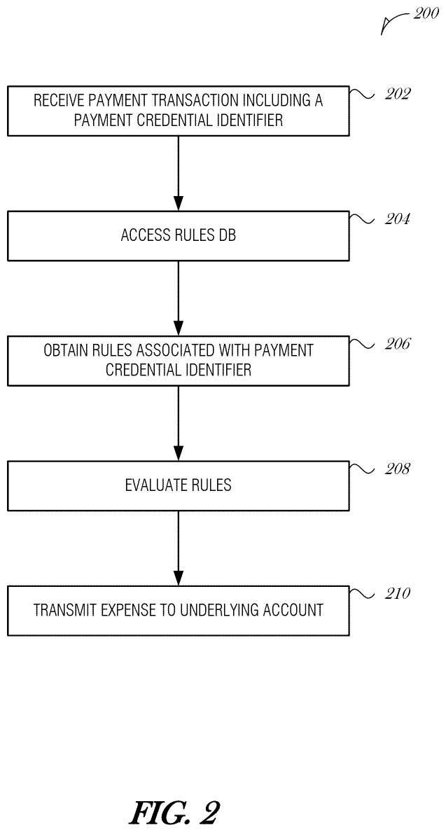

FIG. 2 is a flow diagram illustrating a process 200 for evaluating rules, according to an embodiment. At operation 202, a payment transaction is received from a payment network. The payment transaction includes a group payment account. The payment transaction may include various aspects of the transaction, such as a payment credential identifier (e.g., credit card number), a merchant name, a merchant category code (MCC), a purchase amount, a date and time of the transaction, a location of the transaction, etc. At operation 204, a rules database is accessed. At operation 206, rules associated with the payment credential and the provided group payment account are retrieved and evaluated to determine which underlying account to use. The rules may be based on various aspects of the transaction, such as which group payment account is being used, the geographic location of the transaction, a time of the transaction, a MCC of the transaction, an amount of the transaction, or the like. At operation 208, the rules are evaluated. At 210, based on the rules, the identified underlying accounts are used to complete the transaction.

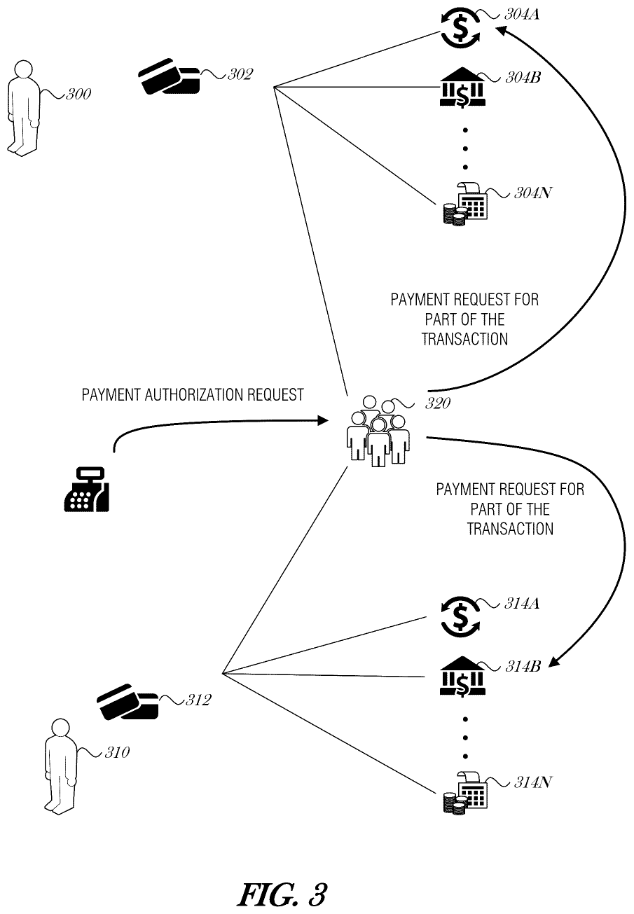

FIG. 3 is a diagram illustrating an arrangement of group members in a group payment account, according to an embodiment. The members include a first member 300 and a second member 310. The first member 300 holds a first flexible credential 302 that is linked to two or more funding sources 304A, 304B, . . . , 304N. The funding sources may include various funding sources as discussed above, such as a line of credit, a deposit account, a prepaid card account, a pre-tax account, an investment account, a FinTech account (e.g., a PayPal or Square account), a “buy now and pay later” account, or the like. The funding sources 304A-N may be from the same issuing bank or from different issuing banks. Similarly, the second member 310 holds a second flexible credential 312 that is linked to two or more funding sources 314A, 314B, . . . , 314N.

Either the first member 300 or second member 310 may establish a group payment account 320 that is to be shared between at least the first member 300 and the second member 310. Other people may be added to the group payment account 320. Additionally, one or both of the first member 300 and second member 310 may be removed from the group payment account 320.

The group payment account 320 may be established for a temporary purpose, such as to help organize expenses during a two-week vacation where at least the first member 300 and the second member 310 are participating.

Optionally, the group payment account 320 may be used for a longer period, either on a consistent basis or a periodic basis (e.g., during annual holidays).

One or more of the members 300, 310 may configure rules for the group payment account. The rules may be used to identify a pending transaction to the group payment account, separate the amount of the transaction among the group members of the group payment account 320, and settle the separate amounts to each of the underlying accounts of the group members for their respective share. In some embodiments, the group payment account 320 itself is not a deposit account, credit line, or other payment vehicle. Instead, it is used as a transactional layer to the underlying linked accounts of each of the members of the group payment account 320.

For instance, the first member 300 may establish the group payment account 320 and link their credit card account 304A with the group payment account. The group payment account 320 may have an account number (e.g., a primary account number (PAN)). The account number may be in a credit card format (e.g., four sets of four numbers, a number of digits in the range thirteen to nineteen, etc.). The issuing authority of the group payment account, which may be the same issuing bank as the credit card account 304A or a different issuing bank. The issuing authority of the group payment account 320 maintains a database mapping the PAN of the group payment account 320 to each respective member's underlying account, which may be identified with a payment token or the underlying account's PAN, in various embodiments.

When a transaction is initiated, for instance, when a member 300 pays for goods or services using their first flexible credential 302, the payment token used identifies the group payment account 320. The transaction is sent through the payment network to the group payment account 320 issuing authority. There, the rules are evaluated, and separate dependent transactions are initiated to each of the group member's underlying accounts.

For example, when the first member 300 and second member 310 are on vacation, they may use a group payment account 320 named “European Vacation 2025.” This account may be accessed and configured through a mobile app on one of the group member's mobile devices. When out for dinner, based on a pre-arranged agreement that all dinners are split evenly regardless of the actual allocations, the first group member 300 may present their first flexible credential 302 to the hostess to pay for the dinner. Prior to processing the transaction, the first group member may configure the first flexible credential 302 to use the group payment account 320 for payment processing. The payment transaction is initiated at the restaurant's point of sale and is directed to the group payment account 320. The systems at the issuing authority of the group payment account 320 is then able to parse the transaction, identify that it is for food (e.g., by analyzing the MCC), and then based on rules, split the transaction amount between the group members (e.g., divide it in half when there are two members). Then the systems at the issuing authority can initiate new payment transactions to each of the underlying accounts, which may be the credit card account 304A for the first member 300, and a deposit account 314B for the second member 310. Once the underlying transactions clear, then the initial transaction for the group payment account 320 is able to return a success indicator.

If there are issues with one or more of the underlying account transactions, such as insufficient funds in a deposit account or where a credit card is declined, the error state may be returned in an unsuccessful indicator to the restaurant point of sale terminal. The unsuccessful indicator may include details of why the transaction failed. Optionally, the member who caused the transaction failure may be notified out of band. For instance, the first member 300 who had insufficient credit available may receive a text message from the issuing bank of the credit card 304A informing the first member 300 that the transaction was declined. As another example, the second member 310 who had insufficient funds in their deposit account 314B may receive a phone call with a message indicating that a recent transaction failed due to insufficient funds. In such a case, the member may change their underlying linked account using the mobile app, and the transaction through the group payment account 320 may be retried.

In another example use case, for a vacation, it may be agreed that the first member 300 may be responsible for all meal charges and the second member 310 may be responsible for all accommodations (e.g., hotel, bed and breakfast, etc.). In this situation, regardless of who actually presents their flexible credential, the group payment account 320 is used to satisfy the rules and pass the charges through to the responsible party. For instance, if the second member 310 presents their flexible credential 312 to pay for a meal, then based on the rules, the charges for the entire meal—not just the portion that was for the first member 300—are charged to the underlying account of the first member 300 linked to the group payment account 320 (e.g., credit card 304A). In this way, the agreement between the members is upheld with very little effort by either of the members.

Members of the group payment account 320 may be notified of attempted charges before they post. For instance, the first member 300 may initiate a payment transaction to a merchant for food, and the first member 300 and the second member 310 may each be notified of some portion of the payment transaction that is attempting to post to their respective accounts. The notification may be performed using various communication channels, which may be configured by the respective member, such as via email, phone call, text message, application notification, etc. Depending on the configuration, pre-approval from each member may be required before processing the transaction. Alternatively, the notifications may be used as informational notices to help members detect potential fraud, but feedback, such as consent or approval is not required to process the transaction.

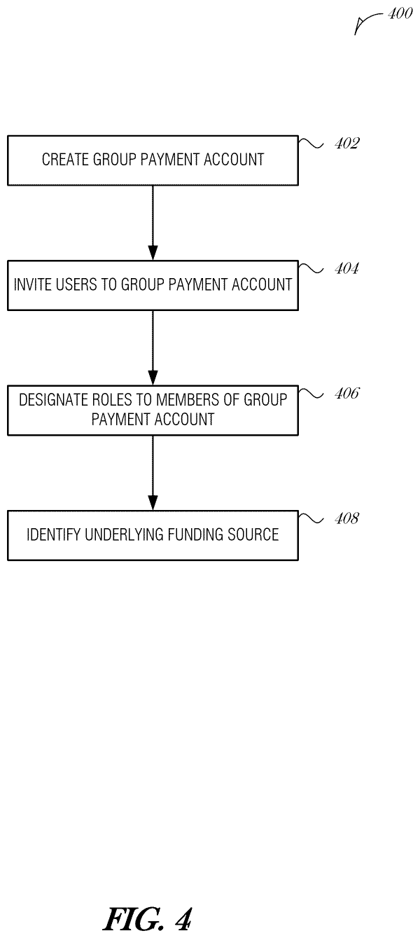

FIG. 4 is a flowchart illustrating a method 400 for forming a group payment account, according to an embodiment. At 402, a user creates a group payment account at an issuing bank. The user may access an application provided by the issuing bank through the Internet or other communication network. The application may be accessed by various user client applications, such as via a website, a mobile app, an automated teller machine (ATM), or the like. To create the group, the user may be required to provide information such as a name or description of the group payment account. Optional parameters may be provided by the user, such as a beginning and ending date or time that the group payment account is active, a preferred payment network, and a list of members.

At 404, one or more other users are invited to the group payment account. During creation or configuration of the group payment account, users may be identified with some unique identifier, such as a telephone number, an email address, a login name, or the like. The forming member may use the application provided by the issuing bank to invite the other users.

Users who are new to the group payment account platform may have to download a mobile app, register, or authenticate with the group payment account platform before accepting an invitation to join the group payment account.

At 406, the forming member may designate roles to one or more members of the group payment account. Roles may allow members to manage rules (e.g., create, edit, delete), add or remove members, change communication preferences (e.g., notifications of account activity at the group payment account level), or the like.

At 408, each member of the group payment account is required to designate an underlying funding source. For example, the founding member may input a credit card number of an account that is the funding source for their portion of any payments due. Another member may provide a bank routing number and checking account number to provide their funding source. Another member may provide a username or other identifier for a FinTech funding source (e.g., a PayPal account name or email address, a Venmo handle, a mobile phone number for Zelle, etc.).

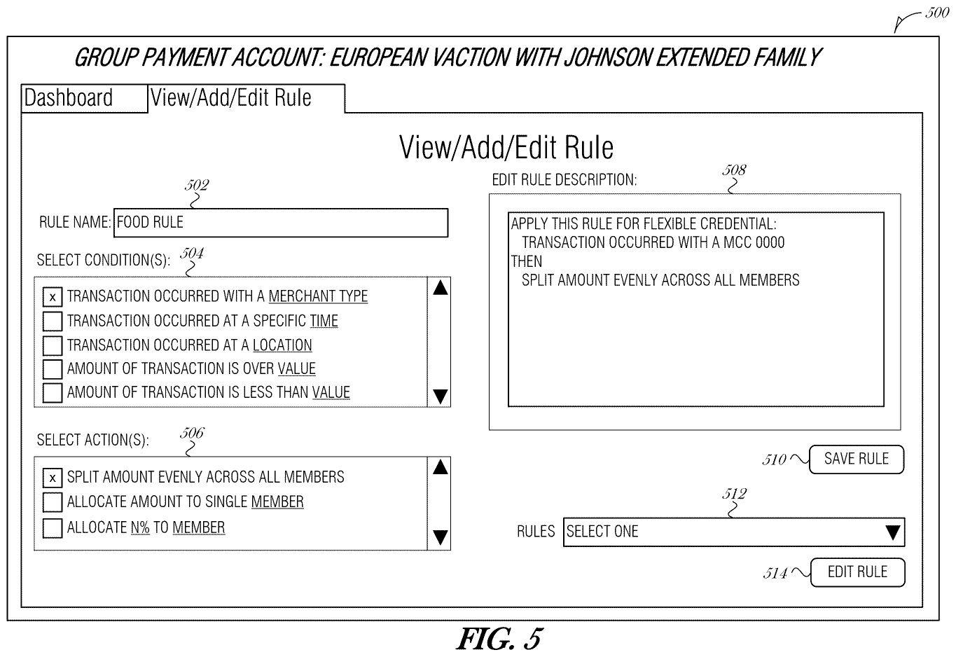

FIG. 5 is an example user interface 500 of an application used to configure rules, according to an embodiment. To add a new rule, a user may provide a name for the rule in a rule name text input control 502. Then the user may select one or more conditions from the conditions selection control 504. The conditions listed in the conditions selection control 504 are merely examples. More or fewer conditions may be implemented. The user may then select one or more actions from the actions selection control 506.

When a user selects a condition from the conditions selection control 504, the condition is added to the rule description 508. Similarly, when the user selects an action from the actions selection control 506, it is added to the rule description 508. In the rule description 508, the user may further define the condition or the action. In the example illustrated in FIG. 5, the conditions and actions include underlined portions. These underlined portions indicate the configurable portion of the rule.

For instance, when the user selects the condition about the “merchant type”, a popup window or other user interface may be provided to the user to select or input the merchant type to use in the condition. In the example shown, the user may select a merchant code that covers restaurants (e.g., MCC 5812), bars (e.g., MCC 5813), or fast food restaurants (e.g., MCC 5814). Multiple conditions may be used with logical AND or OR connectors.

Similarly, the user may select the action when the charge is for a certain MCC, for example, to evenly split the check or allocate to a single member. Other types of conditions or actions may be created by the group payment account platform, depending on the capabilities of the platform.

Alternatively, conditions or actions may be defined by one or more of the members. Once the user has the rule defined, the save button 510 is used to save the rule's settings.

To edit an existing rule, the user may use the select rule dropdown control 512 to select a rule and then when the user presses the edit button 514, the rule and its details are displayed in the rule name field 502, conditions selection control 504, actions selection control 506, and rule description 508.

The user may modify various attributes of the rule and then save it to overwrite the existing rule.

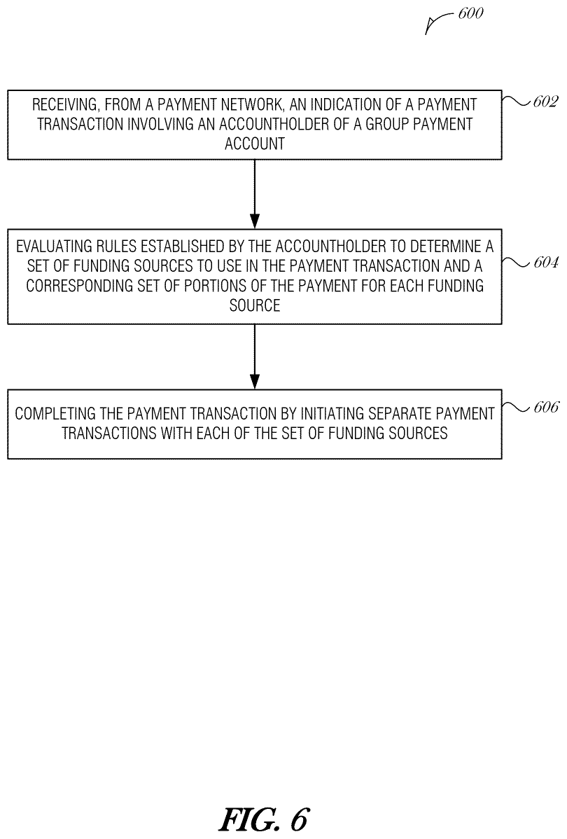

FIG. 6 is a flowchart illustrating a method 600 for processing a transaction for a flexible credential, according to an embodiment. The method 600 may be performed by an electronic system (e.g., issuer bank 102, user device 106, POS terminal device 122, payment network 126) or any of the modules, logic, circuits, processors, or components described herein.

At 602, the method 600 includes the operation of receiving, from a payment network, an indication of a payment transaction involving an accountholder of a group payment account, the payment transaction including a payment amount, the flexible credential linked to the group payment account, and the group payment account including a plurality of members. In embodiments, the payment network is one of: Visa, Mastercard, or Discover. In an embodiment, each of the plurality of members use a respective flexible credential with the group payment account. In an embodiment, the group payment account is active for a configured period.

In an embodiment, the flexible credential is configured to act as both a debit card to draw from a deposit account and a prepaid card to draw from a prepaid account. In a further embodiment, the flexible credential is configured to draw from a line of credit, a pre-tax savings account, or a brokerage account.

In an embodiment, the flexible credential is configured to act as both a debit card to draw from a deposit account and a prepaid card to draw from a prepaid account. In a further embodiment, the flexible credential is configured to draw from a line of credit, a pre-tax savings account, or a brokerage account.

At 604, the method 600 includes the operation of evaluating rules established by the accountholder to determine: a) a set of funding sources to use in the payment transaction, each of the set of funding sources held by a different member of the plurality of members, and b) a respective portion of the payment amount to be allocated to each of the set of funding sources.

At 606, the method 600 includes the operation of completing the payment transaction by initiating separate payment transactions with each of the set of funding sources for the respective portion of the payment amount.

In an embodiment, completing the payment transaction includes transmitting notifications to the plurality of members, the notifications including a mechanism to provide consent for the transaction to proceed and receiving responses from the plurality of members, the responses indicating consent by all of the plurality of members to proceed with the transaction.

In an embodiment, the method 600 includes transmitting informational notices to the plurality of members, the informational notices describing the separate payment transactions with each of the set of funding sources for the respective portion of the payment amount.

In an embodiment, completing the payment transaction includes transmitting notifications to the plurality of members, the notifications including a mechanism to provide consent for the transaction to proceed and receiving responses from the plurality of members, the responses indicating consent by all of the plurality of members to proceed with the transaction.

In an embodiment, the method 600 includes transmitting informational notices to the plurality of members, the informational notices describing the separate payment transactions with each of the set of funding sources for the respective portion of the payment amount.

In an embodiment, completing the payment transaction includes completing the payment transaction by initiating separate payment transactions with each of the set of funding sources for the respective portion of the payment amount using a different payment processor for each of the set of funding sources.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instruction on the machine-readable medium. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

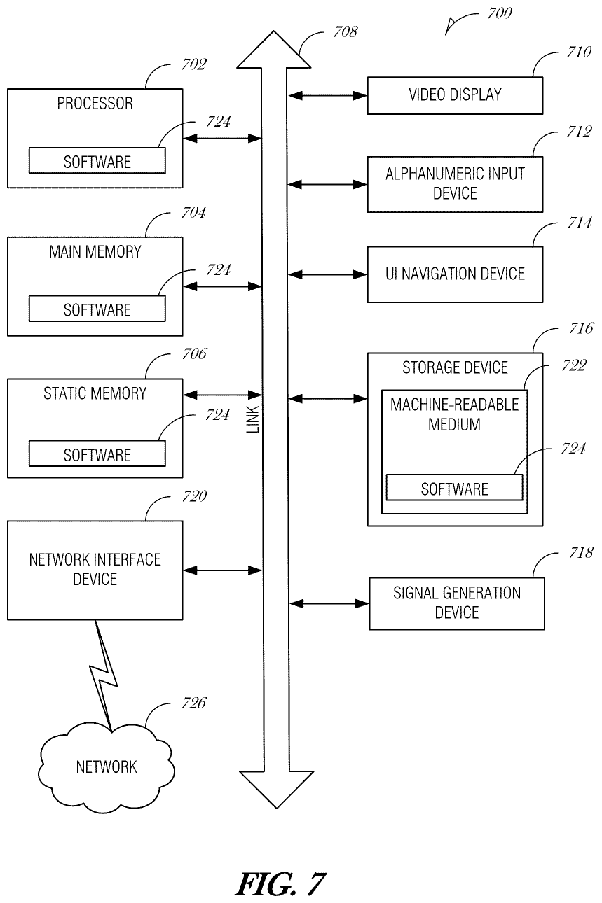

FIG. 7 is a block diagram illustrating a machine in the example form of a computer system 700, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be a wearable device, personal computer (PC), a tablet PC, a hybrid tablet, a personal digital assistant (PDA), a mobile telephone, cloud server, web server, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 700 includes at least one processor 702 (e.g., a central processing unit (CPU), a graphics processing unit (GPU) or both, processor cores, compute nodes, etc.), a main memory 704 and a static memory 706, which communicate with each other via a link 708 (e.g., bus). The computer system 700 may further include a video display unit 710, an alphanumeric input device 712 (e.g., a keyboard), and a user interface (UI) navigation device 714 (e.g., a mouse). In one embodiment, the video display unit 710, input device 712 and UI navigation device 714 are incorporated into a touch screen display. The computer system 700 may additionally include a storage device 716 (e.g., a drive unit), a signal generation device 718 (e.g., a speaker), a network interface device 720, and one or more sensors (not shown), such as a global positioning system (GPS) sensor, compass, accelerometer, or other sensor.

The storage device 716 includes a machine-readable medium 722 on which is stored one or more sets of data structures and instructions 724 (e.g., software) embodying or utilized by any one or more of the methodologies or functions described herein. The instructions 724 may also reside, completely or at least partially, within the main memory 704, static memory 706, and/or within the processor 702 during execution thereof by the computer system 700, with the main memory 704, static memory 706, and the processor 702 also constituting machine-readable media.

While the machine-readable medium 722 is illustrated in an example embodiment to be a single medium, the term “machine-readable medium” may include a single medium or multiple media (e.g., a centralized or distributed database, and/or associated caches and servers) that store the one or more instructions 724. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 724 may further be transmitted or received over a communications network 726 using a transmission medium via the network interface device 720 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

### Additional Notes & Examples:

Example 1 is a system for processing a transaction for a flexible credential, the system comprising: a processor subsystem; and memory including instructions, which when executed by the processor subsystem, cause the processor subsystem to: receive, from a payment network, an indication of a payment transaction involving an accountholder of a group payment account, the payment transaction including a payment amount, the flexible credential linked to the group payment account, and the group payment account including a plurality of members; evaluate rules established by the accountholder to determine: a) a set of funding sources to use in the payment transaction, each of the set of funding sources held by a different member of the plurality of members, and b) a respective portion of the payment amount to be allocated to each of the set of funding sources; and complete the payment transaction by initiating separate payment transactions with each of the set of funding sources for the respective portion of the payment amount.
In Example 2, the subject matter of Example 1 includes, wherein the payment network is one of: Visa, Mastercard, or Discover.
In Example 3, the subject matter of Examples 1-2 includes, wherein the flexible credential is configured to act as both a debit card to draw from a deposit account and a prepaid card to draw from a prepaid account.
In Example 4, the subject matter of Example 3 includes, wherein the flexible credential is configured to draw from a line of credit, a pre-tax savings account, or a brokerage account.
In Example 5, the subject matter of Examples 1-4 includes, wherein each of the plurality of members use a respective flexible credential with the group payment account.
In Example 6, the subject matter of Examples 1-5 includes, wherein the group payment account is active for a configured period.
In Example 7, the subject matter of Examples 1-6 includes, wherein to complete the payment transaction, the processor subsystem is to: transmit notifications to the plurality of members, the notifications including a mechanism to provide consent for the transaction to proceed; and receive responses from the plurality of members, the responses indicating consent by all of the plurality of members to proceed with the transaction.
In Example 8, the subject matter of Examples 1-7 includes, wherein the processor subsystem is to transmit informational notices to the plurality of members, the informational notices describing the separate payment transactions with each of the set of funding sources for the respective portion of the payment amount.
In Example 9, the subject matter of Examples 1-8 includes, wherein to complete the payment transaction, the processor subsystem is to complete the payment transaction by initiating separate payment transactions with each of the set of funding sources for the respective portion of the payment amount using a different payment processor for each of the set of funding sources.
Example 10 is a method for processing a transaction for a flexible credential, the method performed by an electronic online system, the method comprising: receiving, from a payment network, an indication of a payment transaction involving an accountholder of a group payment account, the payment transaction including a payment amount, the flexible credential linked to the group payment account, and the group payment account including a plurality of members; evaluating rules established by the accountholder to determine: a) a set of funding sources to use in the payment transaction, each of the set of funding sources held by a different member of the plurality of members, and b) a respective portion of the payment amount to be allocated to each of the set of funding sources; and completing the payment transaction by initiating separate payment transactions with each of the set of funding sources for the respective portion of the payment amount.
In Example 11, the subject matter of Example 10 includes, wherein the payment network is one of: Visa, Mastercard, or Discover.
In Example 12, the subject matter of Examples 10-11 includes, wherein the flexible credential is configured to act as both a debit card to draw from a deposit account and a prepaid card to draw from a prepaid account.
In Example 13, the subject matter of Example 12 includes, wherein the flexible credential is configured to draw from a line of credit, a pre-tax savings account, or a brokerage account.
In Example 14, the subject matter of Examples 10-13 includes, wherein each of the plurality of members use a respective flexible credential with the group payment account.
In Example 15, the subject matter of Examples 10-14 includes, wherein the group payment account is active for a configured period.
In Example 16, the subject matter of Examples 10-15 includes, wherein completing the payment transaction comprises: transmitting notifications to the plurality of members, the notifications including a mechanism to provide consent for the transaction to proceed; and receiving responses from the plurality of members, the responses indicating consent by all of the plurality of members to proceed with the transaction.
In Example 17, the subject matter of Examples 10-16 includes, transmitting informational notices to the plurality of members, the informational notices describing the separate payment transactions with each of the set of funding sources for the respective portion of the payment amount.
In Example 18, the subject matter of Examples 10-17 includes, wherein completing the payment transaction comprises completing the payment transaction by initiating separate payment transactions with each of the set of funding sources for the respective portion of the payment amount using a different payment processor for each of the set of funding sources.
Example 19 is a non-transitory machine-readable medium comprising instructions for processing a transaction for a flexible credential, which when executed by a machine in an online system cause the machine to: receive, from a payment network, an indication of a payment transaction involving an accountholder of a group payment account, the payment transaction including a payment amount, the flexible credential linked to the group payment account, and the group payment account including a plurality of members; evaluate rules established by the accountholder to determine: a) a set of funding sources to use in the payment transaction, each of the set of funding sources held by a different member of the plurality of members, and b) a respective portion of the payment amount to be allocated to each of the set of funding sources; and complete the payment transaction by initiating separate payment transactions with each of the set of funding sources for the respective portion of the payment amount.
In Example 20, the subject matter of Example 19 includes, wherein the payment network is one of: Visa, Mastercard, or Discover.
In Example 21, the subject matter of Examples 19-20 includes, wherein the flexible credential is configured to act as both a debit card to draw from a deposit account and a prepaid card to draw from a prepaid account.
In Example 22, the subject matter of Example 21 includes, wherein the flexible credential is configured to draw from a line of credit, a pre-tax savings account, or a brokerage account.
In Example 23, the subject matter of Examples 19-22 includes, wherein each of the plurality of members use a respective flexible credential with the group payment account.
In Example 24, the subject matter of Examples 19-23 includes, wherein the group payment account is active for a configured period.
In Example 25, the subject matter of Examples 19-24 includes, wherein to complete the payment transaction, the instructions cause the machine to: transmit notifications to the plurality of members, the notifications including a mechanism to provide consent for the transaction to proceed; and receive responses from the plurality of members, the responses indicating consent by all of the plurality of members to proceed with the transaction.
In Example 26, the subject matter of Examples 19-25 includes, wherein the instructions cause the machine to transmit informational notices to the plurality of members, the informational notices describing the separate payment transactions with each of the set of funding sources for the respective portion of the payment amount.
In Example 27, the subject matter of Examples 19-26 includes, wherein to complete the payment transaction, the instructions cause the machine to complete the payment transaction by initiating separate payment transactions with each of the set of funding sources for the respective portion of the payment amount using a different payment processor for each of the set of funding sources.
Example 28 is at least one machine-readable medium including instructions that, when executed by processing circuitry, cause the processing circuitry to perform operations to implement of any of Examples 1-27.

Example 29 is an apparatus comprising means to implement of any of Examples 1-27.

Example 30 is a system to implement of any of Examples 1-27.

Example 31 is a method to implement of any of Examples 1-27.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. A system for processing a transaction for a flexible credential, the system comprising:
a processor subsystem, and
memory including instructions, which when executed by the processor subsystem, cause the processor subsystem to:
maintain a database that maps a primary account number (PAN) of a group payment account to a respective underlying funding source of each member of a plurality of members of the group payment account, each respective underlying funding source identified in the database by a payment token or a PAN of the respective underlying funding source:
receive, from a payment network, an indication of a payment transaction involving an accountholder of the group payment account, the payment transaction including a payment amount and the PAN of the group payment account, the flexible credential linked to the group payment account, and the group payment account including a plurality of members;
evaluate rules established by the accountholder to determine: a) a set of funding sources to use in the payment transaction, each of the set of funding sources held by a different member of the plurality of members, and b) a respective portion of the payment amount to be allocated to each of the set of funding sources;
transmit a plurality of notifications respectively to the plurality of members associated with the determined set of funding sources, the plurality of notifications including a mechanism to provide consent for the transaction to proceed;
receive responses from the plurality of members that received the respective plurality of notifications, the responses indicating consent by all of the plurality of members that received the respective plurality of notifications to proceed with the transaction; and
in response to obtaining unanimous consent from all of the plurality of members that received the respective plurality of notifications to proceed with the transaction, complete the payment transaction by identifying, using the database and the PAN of the group payment account, the respective underlying funding source of each of the plurality of members that received the respective plurality of notifications, and initiating separate payment transactions with each of the set of funding sources for the respective portion of the payment amount, each separate payment transaction directed to the respective underlying funding source identified from the database.

2. The system of claim 1, wherein the payment network is one of: Visa, Mastercard, or Discover.

3. The system of claim 1, wherein the flexible credential is configured to act as both a debit card to draw from a deposit account and a prepaid card to draw from a prepaid account.

4. The system of claim 3, wherein the flexible credential is configured to draw from a line of credit, a pre-tax savings account, or a brokerage account.

5. The system of claim 1, wherein each of the plurality of members use a respective flexible credential with the group payment account.

6. The system of claim 1, wherein the group payment account is active for a configured period.

7. (canceled)

8. The system of claim 1, wherein the processor subsystem is to transmit informational notices to the plurality of members, the informational notices describing the separate payment transactions with each of the set of funding sources for the respective portion of the payment amount.

9. The system of claim 1, wherein to complete the payment transaction, the processor subsystem is to complete the payment transaction by initiating separate payment transactions with each of the set of funding sources for the respective portion of the payment amount using a different payment processor for each of the set of funding sources.

10. A method for processing a transaction for a flexible credential, the method performed by an electronic online system, the method comprising:
maintaining a database that maps a primary account number (PAN) of a group payment account to a respective underlying funding source of each member of a plurality of members of the group payment account, each respective underlying funding source identified in the database by a payment token or a PAN of the respective underlying funding source:
receiving, from a payment network, an indication of a payment transaction involving an accountholder of the group payment account, the payment transaction including a payment amount and the PAN of the group payment account, the flexible credential linked to the group payment account, and the group payment account including a plurality of members;
evaluating rules established by the accountholder to determine: a) a set of funding sources to use in the payment transaction, cach of the set of funding sources held by a different member of the plurality of members, and b) a respective portion of the payment amount to be allocated to each of the set of funding sources;
transmitting a plurality of notifications respectively to the plurality of members associated with the determined set of funding sources, the plurality of notifications including a mechanism to provide consent for the transaction to proceed;
receiving responses from the plurality of members that received the respective plurality of notifications, the responses indicating consent by all of the plurality of members that received the respective plurality of notifications to proceed with the transaction; and
in response to obtaining unanimous consent from all of the plurality of members that received the respective plurality of notifications to proceed with the transaction, completing the payment transaction by identifying, using the database and the PAN of the group payment account. the respective underlying funding source of each of the plurality of members that received the respective plurality of notifications, and initiating separate payment transactions with each of the set of funding sources for the respective portion of the payment amount, each separate payment transaction directed to the respective underlying funding source identified from the database.

11. The method of claim 10, wherein the payment network is one of: Visa, Mastercard, or Discover.

12. The method of claim 10, wherein the flexible credential is configured to act as both a debit card to draw from a deposit account and a prepaid card to draw from a prepaid account.

13. The method of claim 12, wherein the flexible credential is configured to draw from a line of credit, a pre-tax savings account, or a brokerage account.

14. The method of claim 10, wherein each of the plurality of members use a respective flexible credential with the group payment account.

15. The method of claim 10, wherein the group payment account is active for a configured period.

16. (canceled)

17. The method of claim 10, comprising:
transmitting informational notices to the plurality of members, the informational notices describing the separate payment transactions with each of the set of funding sources for the respective portion of the payment amount.

18. The method of claim 10, wherein completing the payment transaction comprises completing the payment transaction by initiating separate payment transactions with each of the set of funding sources for the respective portion of the payment amount using a different payment processor for each of the set of funding sources.

19. A non-transitory machine-readable medium comprising instructions for processing a transaction for a flexible credential, which when executed by a machine in an online system cause the machine to:
maintain a database that maps a primary account number (PAN) of a group payment account to a respective underlying funding source of each member of a plurality of members of the group payment account, each respective underlying funding source identified in the database by a payment token or a PAN of the respective underlying funding source;
receive, from a payment network, an indication of a payment transaction involving an accountholder the group payment account, the payment transaction including a payment amount and the PAN of the group payment account, the flexible credential linked to the group payment account, and the group payment account including a plurality of members;
evaluate rules established by the accountholder to determine: a) a set of funding sources to use in the payment transaction, each of the set of funding sources held by a different member of the plurality of members, and b) a respective portion of the payment amount to be allocated to each of the set of funding sources;
transmit a plurality of notifications respectively to the plurality of members associated with the determined set of funding sources, the plurality of notifications including a mechanism to provide consent for the transaction to proceed;
receive responses from the plurality of members that received the respective plurality of notifications, the responses indicating consent by all of the plurality of members that received the respective plurality of notifications to proceed with the transaction; and
in response to obtaining unanimous consent from all of the plurality of members that received the respective plurality of notifications to proceed with the transaction, complete the payment transaction by identifying, using the database and the PAN of the group payment account, the respective underlying funding source of each of the plurality of members that received the respective plurality of notifications, and initiating separate payment transactions with each of the set of funding sources for the respective portion of the payment amount, each separate payment transaction directed to the respective underlying funding source identified from the database.

20. The non-transitory machine-readable medium of claim 19, wherein the flexible credential is configured to act as both a debit card to draw from a deposit account and a prepaid card to draw from a prepaid account.
